(19) United States
(12) Patent Application Publication
(10) Pub. No.: US 2008/0086774 A1
(43) Pub. Date: Apr. 10, 2008

(54) Computer and computer system

(75) Inventors: Akitsugu Kanda, Sagamihara (JP); Takaki Nakamura, Ebina (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/600,986

(22) Filed: Nov. 17, 2006

(30) Foreign Application Priority Data
Oct. 4, 2006 (JP) 2006-272595

(51) Int. Cl. G06F 12/14; G06F 11/00; G06F 12/16; G06F 15/18; G08B 23/00

(52) U.S. Cl. 726/24

(57) ABSTRACT

The NAS device, upon detecting a virus infection of a file sent from a client computer, shuts down operation of any logical volume where the virus-infected file could possibly be stored. By so doing, even if one of the multiple logical volumes should become virus-infected, since it is possible to halt usage of only those logical volumes which could possibly become virus-infected, the spread of secondary damage to other logical volumes by virus infection is preventable while minimizing the operational loss in the computer system.

### BACKGROUND OF THE INVENTION

1. Field of the Invention

The present invention relates to a computer for managing files using virtual memory areas.

2. Description of the Related art

Computer networks that link together a number of computers via a network are used. Some computer networks of this kind have a monitoring device connected with the network. The monitoring device monitors operating conditions of each computer connected on such a computer network and forcibly blocks any computer experiencing an abnormal condition that could affect other devices, such as a computer infected with a virus for example, reducing secondary damage caused by the virus.

Even in a system that uses a computer such as an NAS (Network Attached Storage) device, which is connected to multiple devices via multiple networks and connected to a file storage device for storing files, for managing the store locations of files using a multiplicity of virtual memory areas provided by the storage device, is used. In NAS, when one virtual memory area should become infected by a virus, prevention of secondary damage to other virtual memory areas and computers connected on the network via other virtual memory areas and the NAS device is needed.

However, if the NAS device should be blocked from the network when one or more virtual memory areas become infected with a virus, none of the devices connected on the network will be able to communicate with the NAS device any longer, so that not only will the virus-infected virtual memory areas become unusable, but non-virus-infected virtual memory areas will become unusable as well. The resultant effect on the system as a whole is very large, creating the problem of increased operational loss.

The above issue is not a problem specific to virus infections; the problem occurs wherever the occurrence of some other specific event in one virtual memory area affects other virtual memory areas.

### SUMMARY OF THE INVENTION

With the foregoing in view, it is an object of the present invention, in cases where the occurrence of an event in one virtual memory area affects other virtual memory areas, to provide enhanced prevention of secondary damage caused by the event, in a manner that takes into consideration the effects on the system as a whole.

In order to address the above issue at least in part, the present invention in a first embodiment thereof provides a computer connected to a file storage device and multiple devices via a network, wherein the file storage device stores files.

The computer of the first embodiment essentially comprises:

a plurality of file management modules that manages store locations of the files in the file storage device;

a plurality of mediating modules that controls in relation to transfer of the files between the at least one file management module and the plurality of devices, wherein each of the mediating modules is associated with the at least one file management module;

a detection module that detects the occurrence of an event relating to a target file sent from the device,

a state acquiring module that acquires a management state of the plurality of file management modules;

an analysis module that analyzes association between the plurality of file management modules and the event on the basis of the acquired management state and the event; and

a control module that controls an operation state of the at least file management modules among the plurality of file management modules on the basis of the analysis result, wherein the at least one file management module has association with the event.

According to the computer of the embodiment described above, since the operation state of a file management module having association with an occurring event is controllable separately, the spread of damage caused by the event is preventable, without controlling the operation state of other file management modules not having association with the occurring event.

The present invention in a second embodiment thereof provides a computer system having a file storage device and a plurality of host computers and computers, wherein the plurality of host computers and computers are connected via a first network, wherein the computers and the file storage device are connected via a second network.

In the computer system pertaining to the second embodiment,

the host computer comprises

a communication module that transfers files to and from the computers via the first network;

and the computer comprises

a plurality of file management modules that manage store locations of target files in the file storage device, wherein the target files are sent from the host computer via the second network;

a plurality of mediating modules that controls in relation to transfer of the files between the at least one file management module and the plurality of devices, wherein each of the file management modules are associated with the at least one file management module;

a detection module that detects the occurrence of an event relating to a target file, wherein the target file is sent from the device,

a state acquiring module that acquires a management state of the plurality of file management modules;

an analysis module that analyzes association between the plurality of file management modules and the occurring event, on the basis of the acquired management state and the occurring event; and

a control module that controls an operation state of the at least one file management module among the plurality of file management modules on the basis of the result of the analysis, wherein the at least one file management module has association with the event.

According to the embodiment described above, since only the file management module having association with an event is controlled, secondary damage caused by the occurring event is preventable, while minimizing the impact on the computer system as a whole.

These and other objects, features, aspects, and advantages of the present invention will become more apparent from the following detailed description of the preferred embodiments with the accompanying drawings.

### BRIEF DESCRIPTION OF THE DRAWINGS

FIG. 1 illustrates the system configuration of a computer system in an embodiment.

FIG. 2 illustrates function blocks of an NAS device and a storage device in the embodiment.

FIG. 3A illustrates user OS modules in the NAS device in the embodiment.

FIG. 3B illustrates user OS modules in the NAS device in the embodiment. FIG. 4 illustrates management OS modules in the NAS device in the embodiment.

FIG. 5 illustrates kernel in the NAS device in the embodiment.

FIG. 6 shows an exemplary flowchart of the overall process of a file management module shutdown process in the embodiment.

FIG. 7 illustrates a linked virus scan server management table in the embodiment.

FIG. 8 illustrates content stored in a shared memory area 119 in the embodiment.

FIG. 9 illustrates a command ID table of the kernel in the embodiment.

FIG. 10 shows an exemplary flowchart illustrating a state analysis process in the embodiment.

FIG. 11A-11C illustrate an OS intercommunication state management table in the embodiment.

FIG. 12A-12C illustrate an operation state management table in the embodiment.

FIG. 13 illustrates information stored in a shared memory area 120 in the embodiment.

FIG. 14 shows an exemplary flowchart illustrating a forced shutdown process in the embodiment.

FIG. 15 illustrates content of a file management module management table in the embodiment.

### DESCRIPTION OF THE PREFERRED EMBODIMENT

The embodiment of the invention shall be described hereinbelow while referring to the appropriate drawings.

### A. Embodiment

A1. System Configuration:

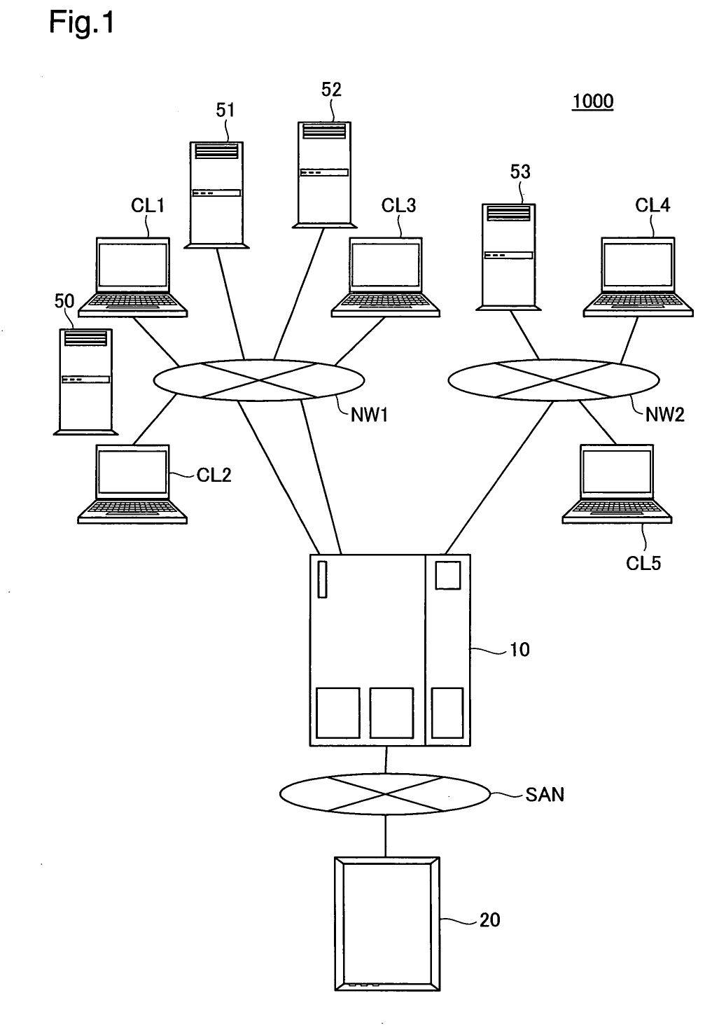

FIG. 1 illustrates system configuration of a computer system 1000 in the embodiment. The computer system 1000 has an NAS (Network Attached Storage) device 10, a storage device 20, client computers CL1-CL5, and virus scan servers 50-53.

The client computers CL1-CL3 and the virus scan servers 50-52 are connected to the NAS device 10 via a network NW1. The client computers CL4 and CL5 and the virus scan server 53 are connected to the NAS device 10 via a network NW2. The networks NW1, NW2 are IP networks that transfer information using the TCP/IP protocol.

The storage device 20 is a large-capacity memory device comprising multiple hard disks in a RAID configuration, and is connected to the NAS device 10 via a network SAN. The use of the RAID configuration affords improved fault tolerance and access speeds. The network SAN transfers information using a SCSI protocol. In the embodiment, the network SAN utilizes Fibre Channel, which is capable of gigabit-order data transfer, as the SCSI protocol, and is set up using optical fiber cable. In the storage device 20, the physical memory areas of the hard disks are partitioned into a plurality of logical volumes (hereinafter termed logical volumes). The storage device 20 manages with a hierarchical structure the store locations of files stored on the hard disks, and associates the logical volumes with the physical memory areas of the hard disks. The storage device 20 provides the NAS device 10 with logical volumes of hierarchical structure.

The NAS device 10 is a computer having a CPU, ROM, and RAM, and has the function of mediating file transfer between the client computers and the storage device. The NAS device 10 manages the file store locations using the logical volumes provided by the storage device. The NAS device 10 in turn provides the client computers with the logical volumes provided to it by the storage device. By storing a file in a logical volume provided by the NAS device 10, a user operating a client computer is able to store the file on the storage device 20. The specifics of the configuration of the NAS device 10 shall be described later.

In the embodiment, the NAS device 10, upon detecting a virus infection of a file sent from a client computer, shuts down operation of any logical volume where the virus-infected file could possibly be stored. By so doing, even if one of the multiple logical volumes should become virus-infected, since usage of only virus-infected logical volumes are able to be shut down, the spread of secondary damage to other logical volumes by virus infection is preventable while minimizing the operational loss in the computer system. The specifics of the configuration and processes of the computer system 1000 shall be described below.

A2. Function Blocks:

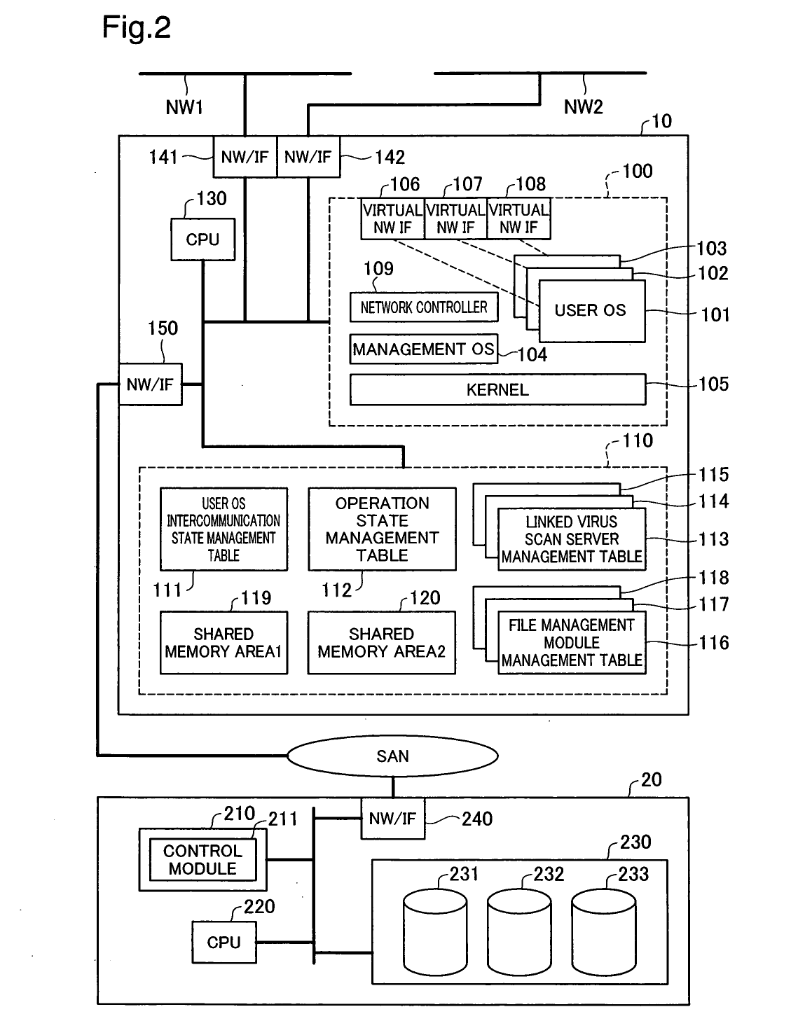

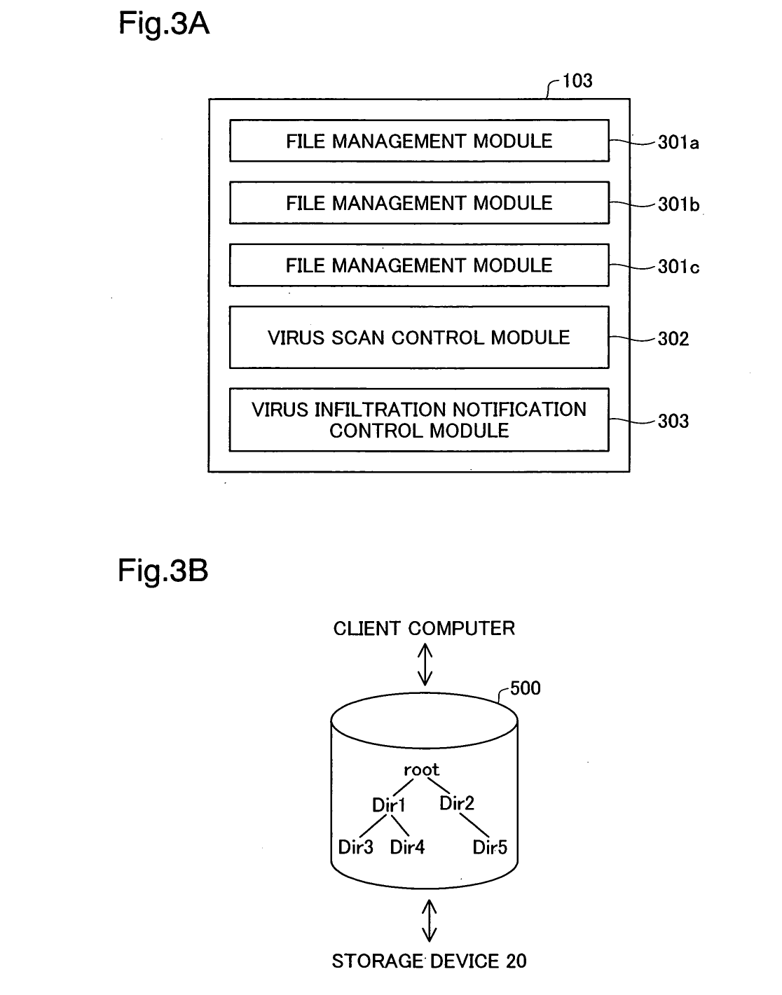

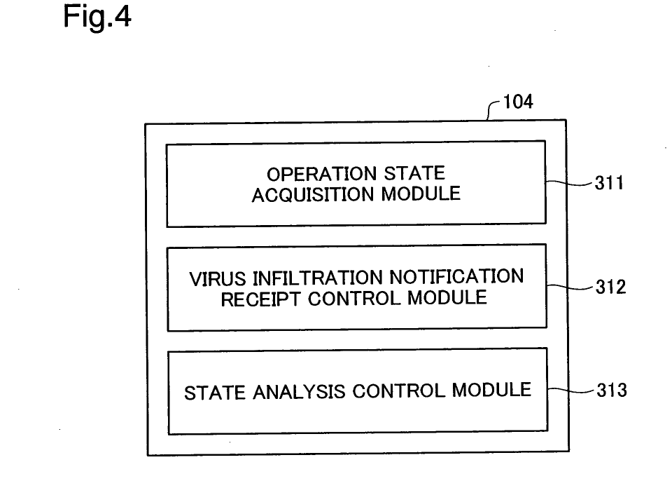

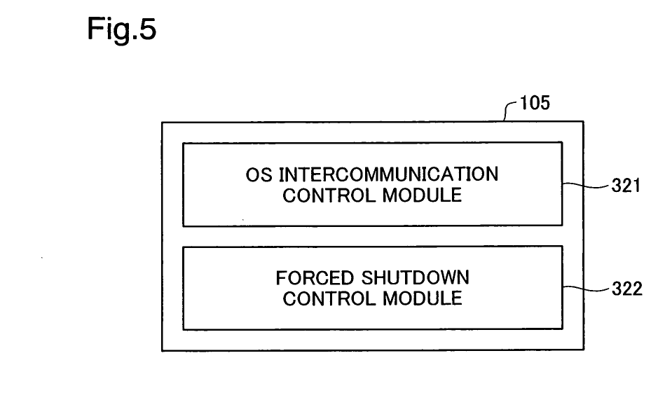

The function blocks of the NAS device 10 and the storage device 20 shall be discussed with reference to FIGS. 2 to 5. FIG. 2 illustrates function blocks of the NAS device 10 and the storage device 20 in the embodiment. FIG. 3 illustrates user OS modules in the NAS device 10 in the embodiment. FIG. 4 illustrates management OS modules in the NAS device 10 in the embodiment. FIG. 5 illustrates kernel in the NAS device 10 in the embodiment.

The storage device 20 shall be discussed. As shown in FIG. 2, the storage device 20 comprises a memory 210, a CPU 220, a data storage unit 230, and a network interface 240. The function blocks are controlled by the CPU 220.

The data storage unit 230 is has three hard disks 231, 232, 233. The data storage unit 230 stores files that have been sent via the NAS device 10 from the client computers CL1-C5 connected to the networks NW1, NW2.

The network interface 240 is a Fibre Channel adaptor used for physical connection to the network SAN. A driver, not shown, for operating the network interface 240 is pre-installed in the memory 210.

The memory 210 is has a control module 211. The control module 211 implements management of the logical volumes, specifically, association of the logical volumes with the data storage unit 230 which constitutes the physical memory area. The control module 211 also controls in relation to communication with the NAS device 10, configuration of the RAID, and backup/restore of data stored in the data storage unit 230.

The NAS device 10 comprises a control memory 100, a nonvolatile memory 110, a CPU 130, and network interfaces 141, 142, 150. The control memory 100 in turn comprises user OS 101-103, a management OS 104, a kernel 105, virtual network interfaces 106-108, and a network controller 109. The nonvolatile memory 110 comprises a user OS intercommunication state management table 111, an operation state management table 112, linked virus scan server management tables 113-115, file management module management tables 116-118, a shared memory area 119, and a shared memory area 120.

The network interface 141 is an adapter used for physical connection to the network NW1. Similarly, the network interface 142 is an adapter used for physical connection to the network NW2.

The network interface 150 is a Fibre Channel adaptor used for physical connection to the network SAN.

Drivers, not shown, for operating the network interfaces 141, 142, 150 are pre-installed in the control memory 100.

The virtual network interfaces 106-108 are modules that function as virtual network adaptors. Normally, a number of IP addresses equal to the number of physical network adapters are set up for a computer; with the virtual network interfaces, IP addresses are able to be set up in numbers equal to the number of virtual network interfaces.

The network controller 109 associates the virtual network interfaces with the user OS, and transfers input data to the associated user OS, via the network interfaces 141, 142, from the client computers connected to the networks NW1, NW2, to the virtual network interfaces 106-108. In the embodiment, the network controller 109 associates the virtual network interface 106 with the user OS 101, the virtual network interface 107 with the user OS 102, and the virtual network interface 108 with the user OS 103.

The user OS 101-103 manages in relation to storage of files sent from the client computers in the storage device 20. The specific modules of the user OS 101-103 shall be described with reference to FIG. 3A, taking the example of the user OS 101. As shown in FIG. 3A, the user OS 101 comprises file management modules 301a-301c, a virus scan control module 302, and a virus infiltration notification control module 303.

The file management module 301a shall be described with reference to FIG. 3B. FIG. 3B is model depiction of operation of a file management module. A logical volume of the storage device 20 is assigned to each file management module, and files are managed using the logical volumes. As shown in FIG. 3B, the logical volume 500 has been assigned to the file management module 301a. Since the logical volume is managed in a hierarchical structure through multiple directories Dir 1, Dir 2, . . . , as shown in FIG. 3, in this embodiment the logical volumes shall hereinafter be termed directory groups. As shown in FIG. 3B, the file management module 301a provides the client computer with a directory group 500 as a file store location. When the file management module 301a receives a request to save a file to the directory group 500, it appends file information indicating the file to the directory group 500, and transfers the file to the storage device 20. By so doing, the user operating the client computer is able to save the file to the storage device 20 simply by saving the file to a desired location in the directory group, so that files is sharable easily without having to consider the hard disk configuration of the storage device 20. In the embodiment, saving of a file to a directory group represents appending file information to the directory group and storing the file in the storage device.

The file management module 301b, 301c have the same arrangement as above, and manage files using the directory groups assigned respectively to directory groups. The user OS 102 and the user OS 103 have the same module arrangement as the user OS 101, and both the user OS 102 and the user OS 103 manage files with three file management modules. Any number of file management modules are establishable in a user OS. In the embodiment, the names of the file management modules 301a-301c shall be denoted as “FS1”-“FS3.” The names of the three file management modules controlled by the user OS 102 shall be denoted as “FS4”-“FS6,” and the names of the three file management modules controlled by the user OS 103 shall be denoted as “FS7”-“FS9.”

The virus scan control module 302, upon receipt of a file save request, queries the virus scan server on the network NW1 associated with the user OS 101 whether the file to be saved is virus-infected, and when a virus is detected, instructs the virus infiltration notification control module 303 to notify of the virus infiltration to the management OS.

The virus infiltration notification control module 303 receives the notification instruction from the virus scan control module 302 and implements notification of the virus infiltration to the management OS 104.

The specific modules of the management OS 104 shall be described with reference to FIG. 4. As shown in FIG. 4, the management OS 104 comprises an operation state acquisition module 311, a virus infiltration notification receipt control module 312, and a state analysis control module 313.

The operation state acquisition module 311 periodically acquires, via the kernel 105, operation state information that represents the operation state of the entire user OS, and saves the acquired operation state information to the operation state management table 112.

The virus infiltration notification receipt control module 312, upon receipt of a virus infiltration notification from the virus scan control module 302 of a user OS, instructs the state analysis control module 313 to initiate state analysis.

The state analysis control module 313, in response to the instruction from the virus infiltration notification receipt control module 312, acquires and analyzes the operation state of the user OS from the operation state management table 112, and instructs the kernel 105 to shut down operation of the file management modules of directory groups that could possibly become infected with the virus.

The modules of the kernel 105 shall be described with reference to FIG. 5. As shown in FIG. 5, the kernel 105 comprises an OS intercommunication control module 321 and a forced shutdown control module 322.

The OS intercommunication control module 321 controls communication between the management OS 104 and the each of the user OS 101-103, and among the OS 101-103.

The forced shutdown control module 322, in response to an instruction from the state analysis control module 313 of the management OS 104, shuts down operation of the file management modules of directory groups that could possibly become infected with a virus.

The tables of the nonvolatile memory 110 shall be described next. The user OS intercommunication state management table 111 stores the communication states among the user OS, specifically, the states of TCP/IP protocol network connections and of network communication using the file sharing protocols NFS (Network File System) and CIFS (Common Internet File System).

The operation state management table 112 stores, for each file management module, the user OS that uses the file management module, IP addresses of the clients permitted to access the directory group of the file management module, and the user IDs permitted to access the directory group of the file management module.

The linked virus scan server management table 113 stores the server name of the virus scan server associated with the user OS 101. The linked virus scan server management table 114 stores the server name of the virus scan server associated with the user OS 102. The linked virus scan server management table 115 stores the server name of the virus scan server associated with the user OS 105.

The file management module management table 116 stores the operation state of the file management module of the user OS 101. The file management module management table 117 stores the operation state of the file management module of the user OS 102. The file management module management table 118 stores the operation state of the file management module of the user OS 103.

The shared areas 119 and 120 are memory areas used when detection of virus infection of files stored in any of the directory groups. They will be described in detail later.

A3. File Management Module Shutdown Process:

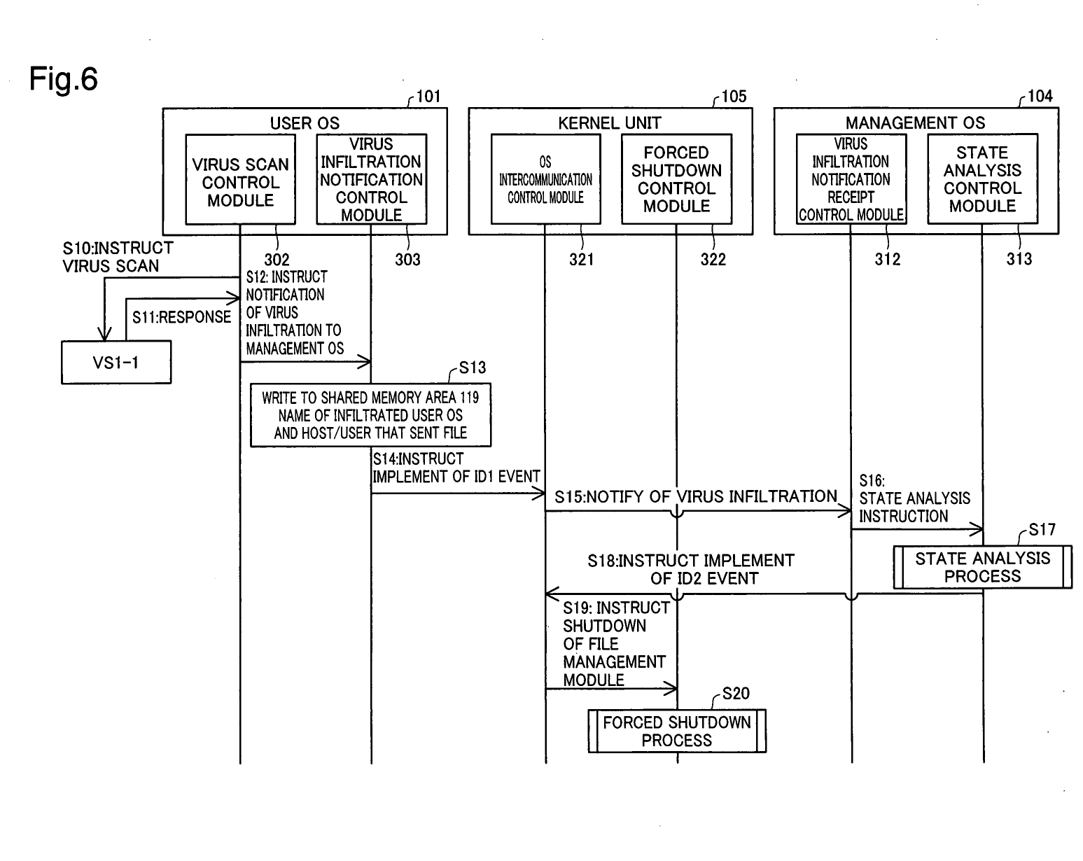

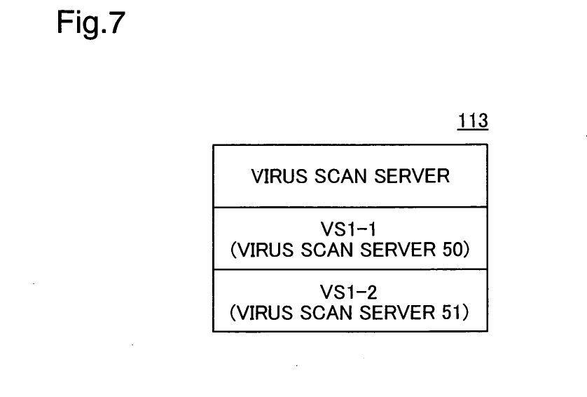

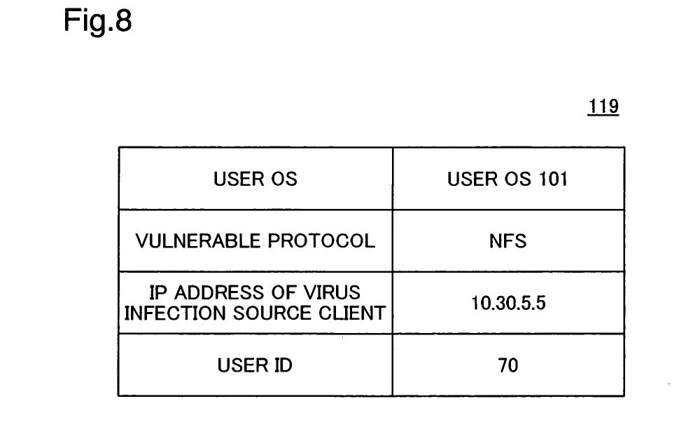

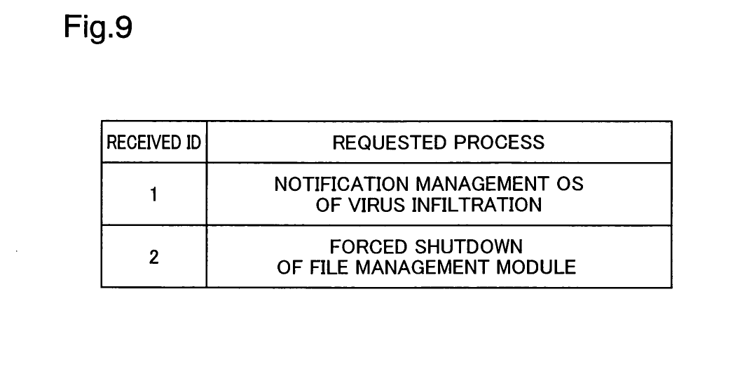

The file management module shutdown process shall be described in detail using FIGS. 6 to 15. First, the overall flow of the file management module shutdown process shall be described with reference to FIGS. 6 to 9. FIG. 6 shows an exemplary flowchart of the overall process of the file management module shutdown process in the embodiment. FIG. 7 illustrates the linked virus scan server management table in the embodiment. FIG. 8 illustrates content stored in the shared memory area 119 in the embodiment. FIG. 9 illustrates the received ID table of the kernel 105 in the embodiment. The file management module shutdown process is implemented cooperatively by the user OS 101-103, the management OS 104, and the kernel 105. In the embodiment, the file management module shutdown process that takes place when a virus-infected file is saved to the directory group of the file management module used by the user OS 101 shall be described.

A3-1. Overall Process Flow:

When a file sent from a client computer is saved to the directory group of the file management module used by the user OS 101, the virus scan control module 302 sends to the virus scan server associated with the user OS 101 an instruction to implement a virus detection process (in the embodiment, hereinafter the virus detection process shall be termed a virus scan) on the saved file (hereinafter termed the target file) (Step S10). Specifically, the virus scan control module 302 of the user OS 101 looks up in the linked virus scan server management table 113 associated with the user OS 101, and acquires information that represents the virus scan server to which the virus scan instruction is targeted. As shown in FIG. 7, the linked virus scan server management table 113 contains stored therein the host name “VS1-1” of a virus scan server 50 and the host name “VS1-2” of a virus scan server 51 that have been associated with the user OS 101. The virus scan control module 302 sends to the virus scan server 50 of the acquired host name “VS1-1” a virus scan instruction that includes the target file's file name, extension, and date/time of most recent update, and a directory path representing the save location of the target file. The virus scan server 51 of the acquired host name “VS1-2” would be used in a case where the virus scan server 50 had become inoperable, due to encountering a fault or the like.

The virus scan control module 302 receives the result of the virus scan from the virus scan server 50 (Step S11), and when a virus infection is detected in the target file, instructs the virus infiltration notification control module 303 to issue a virus infiltration notification to the management OS (Step S12). virus infiltration notification includes the name of the user OS that received the target file, the file sharing protocol used to send the target file, the IP address of the client computer that was the source of the virus infection, and the user ID of the user who sent the target file.

The virus infiltration notification control module 303 receives the virus infiltration notification instruction from the virus scan control module 302, and writes to the shared memory area 119 the name of the user OS that was infected by the virus, the file sharing protocol used to send the target file, the IP address of the client computer that was the source of the virus infection, and the user ID of the user who sent the target file, which have been included in the virus infiltration notification (Step S13).

As shown in FIG. 8, the shared memory area 119 includes four items, namely “user OS”, “vulnerable protocol”, “IP address of virus infection source client”, and “user ID”. The “user OS” indicates the user OS name of the user OS that was infected by the virus, that is, of the user OS that received the target file; the “vulnerable protocol” indicates the file sharing protocol used to send the target file. The “IP address of virus infection source client” indicates the IP address of the client computer that sent the target file, and the “user ID” indicates the user ID of the user who sent the target file. The shared memory area 119 shows that the user OS 101 was infected by the virus, that the target file was sent using the NFS file sharing protocol, and that the target file was sent by the user having the user ID “70” from the computer assigned the IP address “10.30.5.5”.

The virus infiltration notification control module 303 receives the virus infiltration notification instruction from the virus scan control module 302, and then sends a command ID “1” to the OS intercommunication control module 321 of the kernel 105 (Step S14)

Instructions from the user OS 101-103 and the management OS 104 to the kernel 105 are implemented by sending a command ID. The command ID shall be described with reference to FIG. 9. The kernel 105 has a command ID table 600 in advance, shown in FIG. 9. The command ID table 600 includes a “Received ID” field and a “Requested Process” field. The “Received ID” indicates the number of a command ID received from the kernel 105, and the “Requested Process” indicates the content of the process associated with a command ID. For example, as shown in FIG. 9, the process associated with the received ID “1” is “notification of virus infiltration.” Since the kernel 105 manages the resources of the system and controls the transfer of information between hardware and software components, indirect notification of virus infiltration via the kernel 105 is easier in terms of system configuration than is direct notification of virus infiltration from the user OS 101 to the management OS 104; operation of the NAS device 10 will be more stable as well.

When the OS intercommunication control module 321 of the kernel 105 receives the command ID “1,” the OS intercommunication control module 321 implements the requested process associated with command ID “1,” namely, sending a notification of virus infiltration to the virus infiltration notification receipt control module 312 of the management OS 104 (Step S15).

Once the virus infiltration notification receipt control module 312 of the management OS 104 receives the notification of virus infiltration from the OS intercommunication control module 321 of the kernel 105, the virus infiltration notification receipt control module 312 instructs the state analysis control module 313 to analyze the operation state of the file management module (Step S16).

The state analysis control module 313 then analyzes the user OS intercommunication state management table 111 and the operation state management table 112, and extracts therefrom the file management module that uses the directory group in which the target file could possibly be stored (Step S17). In the embodiment, the process of Step S17 is termed the state analysis process. The state analysis process shall be described in detail later.

The state analysis control module 313 then sends a command ID “2” to the OS intercommunication control module 321 of the kernel 105.

Once the OS intercommunication control module 321 receives the command ID “2,” the OS intercommunication control module 321 sends to the forced shutdown control module 322 an instruction to shut down the file management module on the basis of the command ID table 600 (Step S19).

The forced shutdown control module 322 receives the instruction of shut down the file management module, and forcibly shutdowns operation of the file management module 321 that manages the directory group which could possibly be infected with the virus by the target file (Step S20). In the embodiment, the process of Step S20 is termed the forced shutdown process. The forced shutdown process shall be discussed in detail later.

A3-2. State Analysis Process:

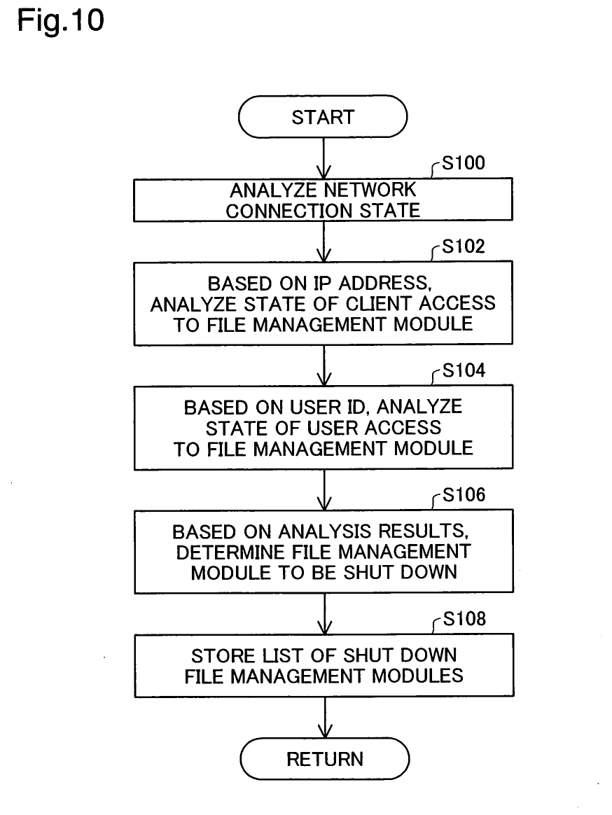

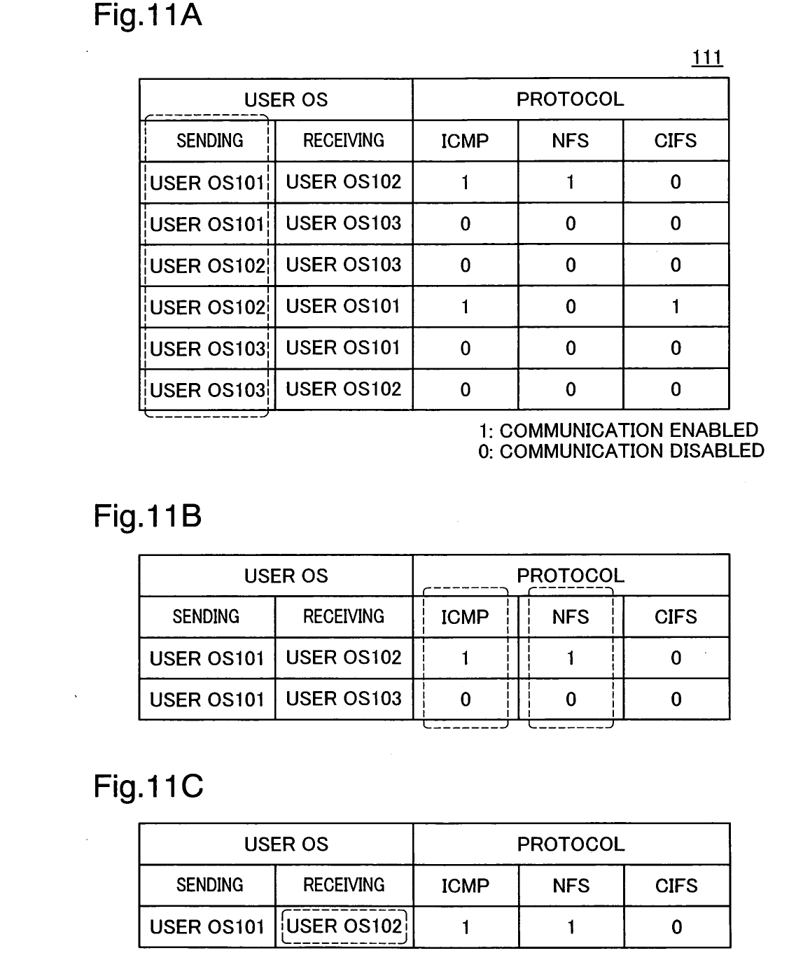

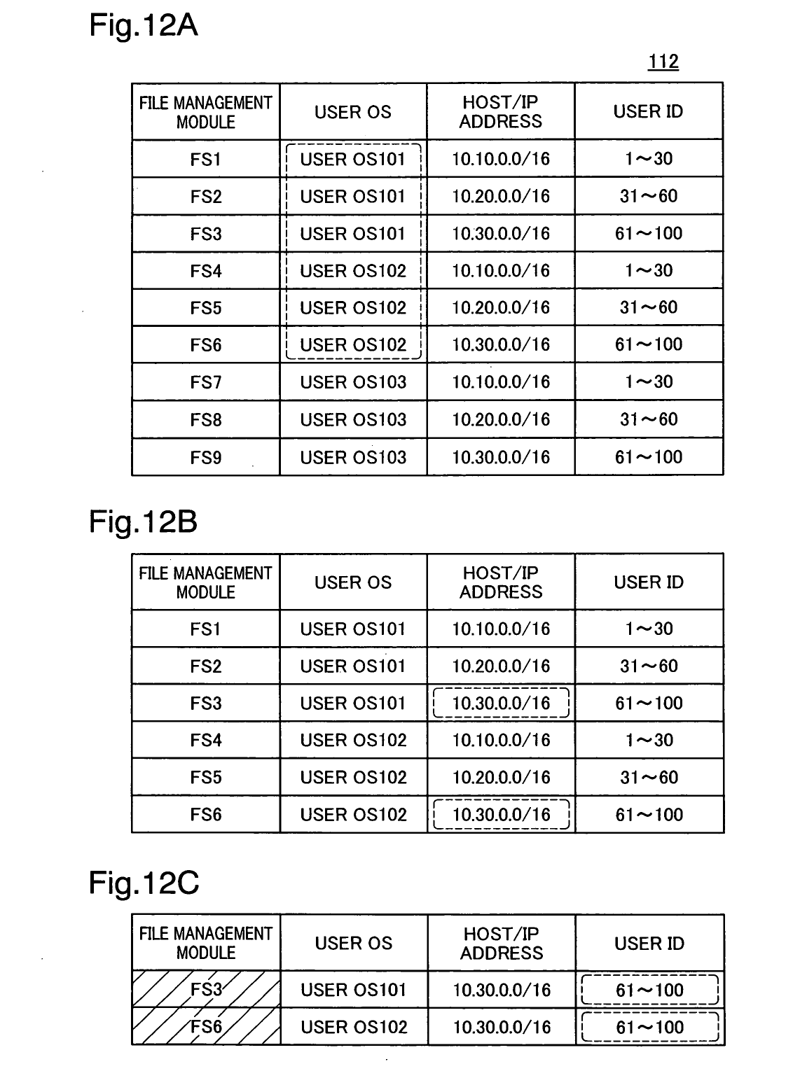

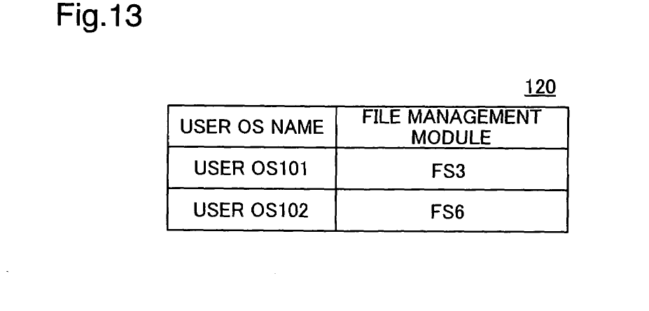

The state analysis process of Step S17 shall now be described in detail with reference to FIGS. 10 to 13. FIG. 10 shows a flowchart illustrating the state analysis process in the embodiment. FIG. 11 illustrates the OS intercommunication state management table 111 in the embodiment. FIG. 12 illustrates the operation state management table 112 in the embodiment. FIG. 13 illustrates information stored in the shared memory area 120 in the embodiment. The state analysis process is implemented by the state analysis control module 313 of the management OS 104.

The state analysis control module 313, referring to the user OS intercommunication state management table 111 and the shared memory area 119, analyzes network connection states among the user OS (Step S100). The OS intercommunication state management table 111 indicates the state of communication using ICMP (Internet Control Message Protocol), NFS, and CIFS among the user OS. ICMP is a protocol for transferring IP error messages or control messages, and represents the protocol used among TCP/IP-networked computers and network devices, to allow these devices to check each other's status. The network diagnostic program Ping uses ICMP.

In the user OS intercommunication state management table 111, a communication enabled state is represented by “1” and a communication disabled state is represented by “0.” For example, as shown in FIG. 11A, where the sending user OS is the user OS 101 and the receiving user OS is the user OS 102, communication using ICMP and communication using NFS both show a “1,” while communication using CIFS shows a “0.” That is, while communication from the user OS 101 to the user OS 102 using ICMP and NFS is possible, communication using CIFS is not possible. Similarly, where the sending user OS is the user OS 102 and the receiving user OS is the user OS 101, communication using ICMP and communication using CIFS both show a “1,” while communication using NFS shows a “0.” That is, while communication from the user OS 102 to the user OS 102 using ICMP and CIFS is possible, communication using NFS is not possible.

As shown in FIG. 11A the state analysis control module 313, referring to the user OS intercommunication state management table 111 and the shared memory area 119, extracts from the user OS intercommunication state management table 111 those rows for which the sending user OS is the same as the virus infected user OS (FIG. 11B). For these extracted rows, the state analysis control module 313, making reference to the communication state using ICMP and the communication state by the file sharing protocol identical to the vulnerable protocol indicated in the shared memory area 119, extracts a row for which communication is possible (FIG. 11C). The state analysis control module 313 then decides that the receiving user OS in this extracted row is a user OS that could possibly become infected by the virus (FIG. 11C). Since the target file that is the source of the virus infection was sent using file sharing protocol, any network-connected user OS with which it is possible to communicate using file sharing protocol could possibly become infected with the virus, if the target file were stored thereon. Accordingly, in the embodiment, the network-connected user OS 102 with which the user OS which is the source of the virus is able to communicate using file sharing protocol is determined to be a user OS having virus infection possibility. In the embodiment, such network connection enabling communication using file sharing protocol shall hereinafter be referred to as “having network connectivity.” In the embodiment, ICMP communication is verified prior to verification of communication using file sharing protocol. The reason is that where communication using ICMP is not possible, it means that the devices are not physically connected at all, so there will be no need to verify the state of communication using file sharing protocol since the target file could not be sent in any case; this allows for a shorter process time.

Next, the state analysis control module 313, making reference to the operation state management table 112 and the shared memory area 119, analyzes on the basis of the IP address the state of access to directory groups by the client computer, and on the basis of the user ID the state of access to directory groups by the user; and from the directory groups used by the virus-infected user OS 101 and the user OS 102 determined in Step S100 to possibly become infected by the virus, extracts those file management modules using directory groups that could possibly become virus infected (Step S102, Step S104).

Before proceeding to a detailed discussion of Steps S102 and 104, the operation state management table 112 shall be discussed referring to FIG. 12A. As shown in FIG. 12A, the operation state management table 112 includes four items, namely, file management module, user OS, host/IP address, and user ID. The “file management module” indicates the name of each file management module, and the “user OS” indicates the user OS controlling each of the file management modules. The “host/IP address” indicates the IP addresses of the client computer having permission to access the directory group used by each file management module, and the “user ID” indicates an ID assigned individually to each user, to users having permission to access the directory group used by each file management module. For example, the file management module “FS2” is managed by the user OS 101, and can be accessed by users with user IDs of 31-60, from the host having the IP address 10.10.0.0/16.

The process of Steps S102 and 104 shall now be described specifically. The state analysis control module 313, referring to the user OS in the operation state management table 112, extracts the rows for the file management modules that are controlled by the currently virus-infected user OS 101, and the user OS 102 having network connectivity with the user OS 101 extracted previously in Step S100 (FIG. 12B). The state analysis control module 313 refers to the IP addresses of the extracted rows, and extracts the row including the “virus infection source client IP address” stored in the shared memory area 119 (FIG. 12C). The state analysis control module 313 then extracts the file management module of the row which, of the extracted rows, includes the user ID of the user who sent the target file which was the source of the virus infection, which has been stored in the shared memory area 119 (FIG. 12C). In the embodiment, the file management modules “FS3” and “FS6” are extracted.

The state analysis control module 313 then decides that these extracted file management modules are the file management module whose operation should be shut down (Step S106), and saves a list of the file management module whose operation should be shut down in the shared memory area 120.

The contents of the shared memory area 120 shall be described with reference to FIG. 13. As shown in FIG. 13, the shared memory area 120 includes two items, namely “User OS” and “File Management Module.” “File Management Module” indicates the file management modules to be shut down, and “User OS” indicates the user OS controlling the file management modules to be shut down. In the embodiment, as shown in FIG. 13, the file management modules targeted to be shut down are the file management modules FS3 and 6.

A3-3. Forced Shutdown Process:

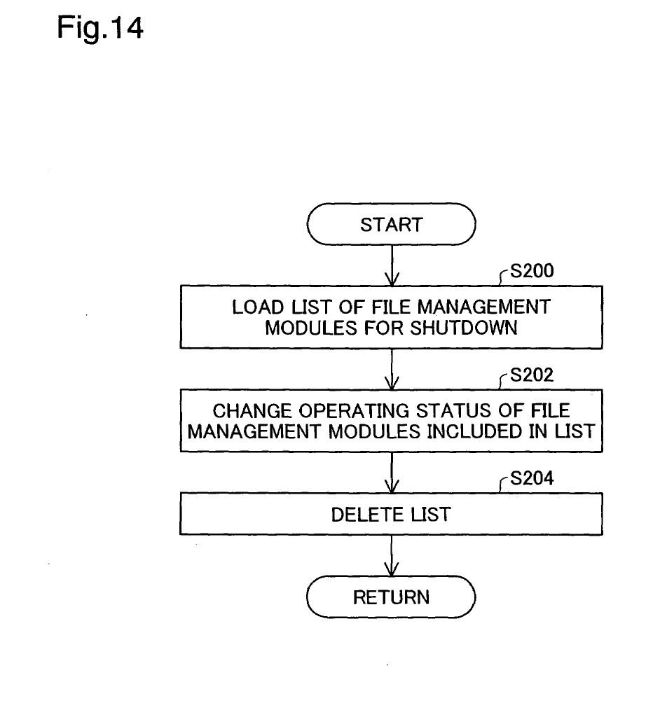

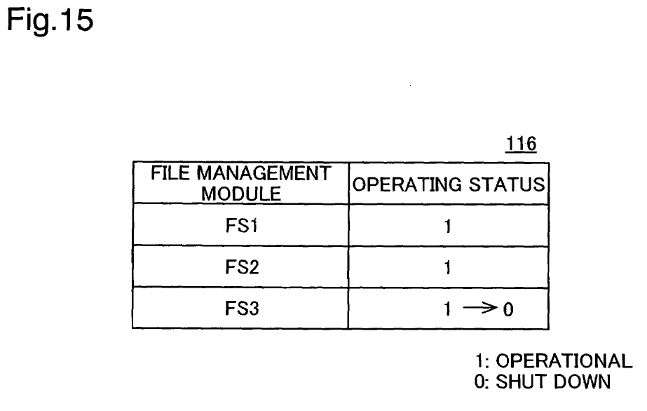

The forced shutdown process for forced shutdown of the file management modules targeted to be shut down determined in the above manner (Step S20 of FIG. 6) shall be discussed with reference to FIG. 14 and FIG. 15. FIG. 14 shows a flowchart illustrating the forced shutdown process in the embodiment. FIG. 15 illustrates content of the file management module management table 117 in the embodiment. The forced shutdown process is implemented by the forced shutdown control module 322 of the kernel 105.

The forced shutdown control module 322 refers to the shared memory area 120 and loads the list of file management modules to be shut down (Step S200).

Of the file management modules contained in the file management module management tables 116-118, the forced shutdown control module 322 forces a change of operating status of all file management modules that are included in the loaded list (Step S202)

The file management module management tables 116-118 shall be described with reference to FIG. 15, taking the example of the file management module management table 116. The file management module management table 116 represents the file management modules controlled by the user OS 101, and includes two items, namely, “File Management Module” and “Operating Status.” “Operating Status” represents the operation state of each file management module. In the embodiment, an operating status of “1” indicates that the file management module is operational, while an operating status of “0” indicates that the file management module is shut down. In the file management module management table 116 shown in FIG. 15, all of the file management modules utilized by the user OS 101 are operational. In the embodiment, the forced shutdown control module 322 halts operation of the file management module “FS3” of the user OS 101 and of the file management module “FS6” of the user OS 102, which are the file management modules included in the list read from the shared memory area 120. Specifically, the forced shutdown control module 322 forcibly sets to “0” the operating status of the file management module “FS3” of the file management module management table 116 of the user OS 101 and of the file management module “FS6” of the file management module management table 117 of the user OS 102. The file management modules whose operating status has been set to “0” are now shut down.

According to the computer system 1000 of the embodiment discussed hereinabove, in an NAS device 10 that manages files using directory groups, when a virus infection is detected in a directory group used by one file management module, only the file management module that uses the virus-infected directory group and file management modules using other directory groups that could possibly become infected are forcibly shut down, whereby secondary damage caused by virus infection is preventable without shutting down the NAS device 10 itself. Consequently, stability is improvable in association with preventing virus infection of the numerous files stored in the storage device 20, and operational loss on the part of the computer system 1000 is able to be minimized.

According to the computer system of the embodiment, the NAS device 10 periodically acquires and manages states of the user OS, for example, operating status, permissions to access directory groups used by file management modules, and OS intercommunication states, and therefore when a virus is detected, a process to shut down the file management modules is implementable immediately, and spread of damage by the virus is able to be suppressed early on.

Moreover, according to the computer system of the embodiment, virus scanning is referred to separately constituted virus scan servers, so the processing load on the NAS device can be reduced.

### B. Variation Embodiment

(1) Whereas in the preceding embodiment, virus scanning is referred to virus scan servers connected to the networks NW1, NW2, but instead the NAS device 10 could be provided with a virus scan function, for example. By so doing, virus scanning is implementable without issuing instructions to a virus scan server, so processing time is able to be reduced.

(2) In the embodiment, file management modules to be shut down are determined in a detailed manner based on client computer access permissions and user access permissions, but it would be possible to instead shut down all file management modules controlled by user OS that have network connectivity with the user OS actually infected by the virus, for example. By so doing, user OS not having network connectivity with the user OS that has been actually infected by a virus is able to be kept operational without being shut down, so damage by a virus is able to be prevented early on. Damage by a virus is also able to be prevented early on without refining the determination of management modules to be shut down by user access permissions, by instead shutting down all file management modules extracted during refinement by client computer IP address.

(3) In the embodiment, the operation state acquisition module 311 of the NAS device periodically acquires the operation state of the file management modules, but could instead acquire the operation state when a virus is detected, for example. By so doing it is possible to acquire the most recent operation state when the virus is detected, so that the file management modules to be shut down are able to be determined with greater accuracy.

Although the present invention has been described and illustrated in detail, it is clearly understood that the same is by way of illustration and example only and is not to be taken by way of limitation, the spirit and scope of the present invention being limited only by the terms of the appended claims.

The Japanese patent applications as the basis of the priority claim of this application are incorporated in the disclosure here of by reference:

(1) Japanese Patent Application No. 2006-272595 (filing data: Oct. 04, 2006).

What is claimed is:

1. A computer connected to a file storage device and multiple devices via a network, wherein the file storage device stores files, the computer comprising:
a plurality of file management modules that manages store locations of the files in the file storage device;
a plurality of mediating modules that controls in relation to transfer of the files between the at least one file management module and the plurality of devices, wherein each of the mediating modules is associated with the at least one file management module;
a detection module that detects the occurrence of an event relating to a target file sent from the device,
a state acquiring module that acquires a management state of the plurality of file management modules;
an analysis module that analyzes association between the plurality of file management modules and the event on the basis of the acquired management state and the event; and
a control module that controls an operation state of the at least file management modules among the plurality of file management modules on the basis of the analysis result, wherein the at least one file management module has association with the event.

2. The computer according to claim 1 wherein the event includes a virus infection of the target file;
the association between the plurality of file management modules and the event includes the virus infection probability of the plurality of file management modules by the target file; and
control of the operation state includes shutdown of the file management modules.

3. The computer according to claim 1 wherein
the analysis module analyzes the network connection state, of the plurality of mediating modules, between a first mediating module and another mediating module, wherein the first mediating module and the another mediating module transfers the target file; and
the control module controls, among the plurality of mediating modules, the file management module associated with the first mediating module and f the file management module associated with a second mediating module, wherein the second mediating module is connected with the first mediating module via the network.

4. The computer according to claim 1 wherein
each of the mediating modules further manages access permissions representing whether to allow the plurality of devices to access the individually associated file management modules;
the analysis module analyzes the file management modules allowed access by a sending device, wherein the sending device is the sender of the target file; and
the control module controls the file management modules accessible by the sending device.

5. The computer according to claim 1 wherein
the mediating modules further manage user access permissions representing whether to allow users to access the individually associated file management modules;
the analysis module analyzes the file management modules allowed access by the sending user, wherein the sending user is sender of the target file; and
the control module controls the file management modules accessible by the sending user.

6. The computer according to claim 1 wherein
the analysis module analyzes a state of communication using the file sharing protocol between the first mediating module and the other mediating module, wherein the first mediating module mediates the target file; and
the control module controls the file management module associated with a second mediating module, wherein the second mediating module is able to be communicated from the first mediating module using the file sharing protocol.

7. The computer according to claim 6 wherein
the analysis module analyzes the network connection state between the first mediating module and the other mediating module prior to analyzing the state of communication using the file sharing protocol, and analyzes the state of communication using the file sharing protocol between the second mediating module and the first mediating module when the second mediating module connected with the first mediating module via the network presents.

8. The computer according to claim 6 wherein
the file sharing protocol includes at least one of the Common Internet File System and the Network File System.

9. The computer according to claim 2 wherein
the detection module detects whether the target file is infected with a virus by querying a virus detection device among the plurality of devices and receiving a response to the query.

10. The computer according to claim 2 further comprising:
a decision module that decides whether the target file is infected;
the detection module detects the virus infection based on the decision result.

11. The computer according to claim 1 further comprising:
a state storage that stores the management states acquired by the state acquiring module; and
a monitoring module that periodically monitors the management states and storing the management states in the state storage;
the state acquiring module acquires the management states referring to the state storage.

12. The computer according to claim 1 wherein
the state acquiring module acquires the management states when occurrence of the event is detected.

13. A computer system having a file storage device and a plurality of host computers and computers, wherein the plurality of host computers and computers are connected via a first network, wherein the computers and the file storage device are connected via a second network, and wherein
the host computer comprises
a communication module that transfers files to and from the computers via the first network;
and the computer comprises
a plurality of file management modules that manage store locations of target files in the file storage device, wherein the target files are sent from the host computer via the second network;
a plurality of mediating modules that controls in relation to transfer of the files between the at least one file management module and the plurality of devices, wherein each of the file management modules are associated with the at least one file management module;
a detection module that detects the occurrence of an event relating to a target file, wherein the target file is sent from the device,
a state acquiring module that acquires a management state of the plurality of file management modules;
an analysis module that analyzes association between the plurality of file management modules and the occurring event, on the basis of the acquired management state and the occurring event; and
a control module that controls an operation state of the at least one file management module among the plurality of file management modules on the basis of the result of the analysis, wherein the at least one file management module has association with the event.

14. A file management method implemented by a computer, wherein the computer is connected to a file storage device and multiple devices via a network, and comprises a plurality of file management modules, wherein the file storage device stores files, wherein the file management modules manage store locations of the files in the file storage device, the method comprising:
controlling in relation to transfer of the files between the at least one file management module and the plurality of devices;
detecting the occurrence of an event relating to a target file, wherein the target file is sent from the device,
acquiring the management state of the plurality of file management modules;
analyzing association between the plurality of file management modules and the occurring event on the basis of the acquired management state and the occurring event; and
controlling an operation state of the at least one file management module among the plurality of file management modules on the basis of the result of the analysis, wherein the at least one file management module has association with the event.

15. A file management method implemented by a computer system, wherein the computer system has a file storage device and a plurality of host computers and computers, wherein the plurality of host computers and the computers are connected via a first network, wherein the computers and the file storage device are connected via a second network, wherein the computer has a plurality of file management modules that manage store locations of target file in the file storage device, wherein the target files are sent from the host computer, wherein
the host computer comprises
sending the target files to the computer via the first network; and
the computer comprises
controlling in relation to transfer of the files between the at least one file management module and the plurality of devices;
detecting the occurrence of an event relating to a target file, wherein the target file is sent from the device,
acquiring the management state of the plurality of file management modules;
analyzing association between the plurality of file management modules and the occurring event on the basis of the acquired management state and the occurring event; and controlling an operation state of the at least one file management module among the plurality of file management modules on the basis of the result of the analysis, wherein the at least one file management module has association with the event.
